(19) United States
(12) Patent Application Publication
(10) Pub. No.: US 2016/0261412 A1
(43) Pub. Date: Sep. 8, 2016

(54) Two-Step Authentication And Activation of Quad Small Form Factor Pluggable (QFSP+) Transceivers

(71) Applicant: Avaya Inc., Basking Ridge, NJ (US)

(72) Inventors: Robert Lee, Lexington, MA (US); Tamiji Homma, Newbury Park, CA (US); Vikram Ramachandran, Andover, MA (US)

(73) Assignee: Avaya Inc., Basking Ridge, NJ (US)

(21) Appl. No.: 14/637,568

(22) Filed: Mar. 4, 2015

(51) Int. Cl. H04L 9/32; G06F 12/14

(52) U.S. Cl. CPC H04L 9/3242; H04L 9/3226; G06F 12/1433; G06F 12/1408; G06F 2212/1052

(57) ABSTRACT

A method and apparatus for providing a two-step authentication and activation process for QSFP+ transceivers is presented. A first hashed password is generated using a first encoding library, the first hashed password used for validating a component, the component having a memory, the memory having a protected part and an unprotected part. A first hidden hash string is generated using the first encoding library, the first hidden hash string used for validating the component. The first hashed password is used to program the first hashed password into a protected part of the component and to write the first hidden hash string into the protected part of the component, which are later verified when the component is integrated into the system. The component is only useable if the verification is successful.

### BACKGROUND

The Quad Small Form-Factor Pluggable (QSFP or QFSP+) is a compact, hot-pluggable transceiver used for data communications applications. The terms QFSP and QFSP+ are used interchangeably herein. A QFSP+ interfaces networking hardware to a fiber optic cable. QSFP+ transceivers are an integral component in providing high bandwidth and long distance telecommunications and data communications solutions. Because two are used for every fiber connection between systems, it is a very high volume and highly competitive segment of the market. The use of the correct component for the right application is essential in delivering a solution that works correctly and consistently. Equipment manufacturers go through extensive testing to qualify parts and the correct applications that the parts should be used for.

### SUMMARY

Conventional QFSP+ transceivers and systems that incorporate them suffer from a variety of deficiencies. One such deficiency is that, because of the margins involved there are manufacturers who have tried to sell non-qualified and often inferior parts. Until this point the identification of parts by the systems which use them has been non-systematic and easily subverted. Second market manufacturers will put labels with similar look of qualified parts and also encode the components with part numbers or portions of part numbers. The use of non-qualified parts does damage to the reputation of the applications and also leaves the consumer with higher costs when they have to debug the intermittent and flaky symptoms that accompany the use of non-qualified parts. They also in the end need to replace the non-working part.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

In a particular embodiment of a method for providing a two-step authentication and activation process for QSFP+ transceivers, the method begins with generating a first hashed password using a first encoding library, the first hashed password used for validating a component, the component having a memory, the memory having a protected part and an unprotected part. The method further includes generating a first hidden hash string using the first encoding library, the first hidden hash string used for validating the component. The method further includes using the first hashed password to program the first hashed password into a protected part of the component, and using the first hashed password to unlock the protected part of the component and write the first hidden hash string into the protected part of the component. Other embodiments include a computer readable medium having computer readable code thereon for providing a two-step authentication and activation process for QSFP+ transceivers. The computer readable medium includes instructions for generating a first hashed password using a first encoding library, the first hashed password used for validating a component, the component having a memory, the memory having a protected part and an unprotected part. The computer readable medium further includes instructions for generating a first hidden hash string using the first encoding library, the first hidden hash string used for validating the component. The computer readable medium further includes instructions for using the first hashed password to unlock the protected part of memory and to program the first hidden hash string into the protected part of the component.

Still other embodiments include a computerized device, configured to process all the method operations disclosed herein as embodiments of the invention. In such embodiments, the computerized device includes a memory system, a processor, communications interface in an interconnection mechanism connecting these components. The memory system is encoded with a process that provides a two-step authentication and activation process for QSFP+ transceivers. as explained herein that when performed (e.g. when executing) on the processor, operates as explained herein within the computerized device to perform all of the method embodiments and operations explained herein as embodiments of the invention. Thus any computerized device that performs or is programmed to perform the processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing a two-step authentication and activation process for QSFP+ transceivers as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers or on one computer alone.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Avaya, Inc. of Basking Ridge, N.J.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention. The drawings are not necessarily to scale, emphasis instead being placed upon illustrating the principles of the invention.

FIG. 1 depicts a block diagram of a QFSP+ transceiver in accordance with a particular embodiment of the present invention.

FIG. 2 depicts a flow diagram of a particular embodiment of a method for providing a two-step authentication and activation process for QSFP+ transceivers in accordance with a particular embodiment of the present invention.

FIG. 3 depicts a block diagram of a system for providing a two-step authentication and activation process for QSFP+ transceiver in accordance with a particular embodiment of the present invention.

### DETAILED DESCRIPTION

The embodiments set forth below represent the necessary information to enable those skilled in the art to practice the invention and illustrate the best mode of practicing embodiments of the invention. Upon reading the following description in light of the accompanying figures, those skilled in the art will understand the concepts of the invention and recognize applications of these concepts not particularly addressed herein. It should be understood that these concepts and applications fall within the scope of the disclosure and the accompanying claims.

The preferred embodiment of the invention will now be described with reference to the accompanying drawings. The invention may, however, be embodied in many different forms and should not be construed as limited to the embodiment set forth herein; rather, this embodiment is provided so that this disclosure will be thorough and complete, and will fully convey the scope of the invention to those skilled in the art. The terminology used in the detailed description of the particular embodiment illustrated in the accompanying drawings is not intended to be limiting of the invention. In the drawings, like numbers refer to like elements. The present invention utilizes a two-step process to validate that a QSFP is a qualified component and limit its operation only to qualified components.

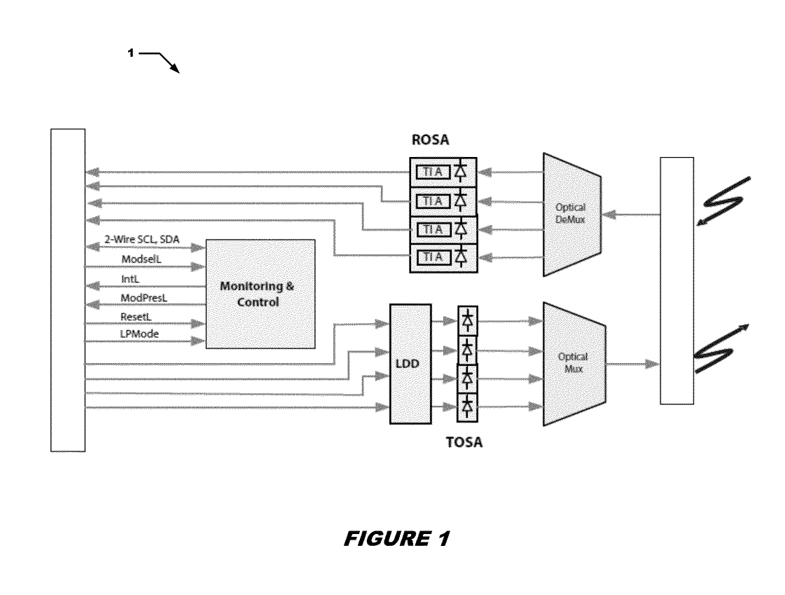

A high level block diagram of a QFSP+ transceiver 1 is shown in FIG. 1. The QSFP+ is a compact, hot-pluggable transceiver used for data communications applications. It interfaces networking hardware to a fiber optic cable. The QSFP specification accommodates different data rate options. QSFP+ transceivers are designed to carry Serial Attached Small Computer Serial Interface (SCSI), 40G Ethernet, Quad Data Rate (QDR) (40G) and Fourteen Data Rate (FDR) (56G) Infiniband, and other communications standards.

A problem addressed by the presently described method and apparatus for providing a two-step authentication and activation process for QSFP+ transceivers is being able to have valid certified QFSP+ components in a system. Parts are manufactured according to specifications. Part of the specification details the memory within the device and what parts of that memory are readable. The QSFP+ device has the ability to lock and unlock areas of memory. The physical memory has a readable part of memory and also has a locked piece of memory which is only accessible by using the valid matching password calculated by the encoding library with the readable memory contents as input. A system manufacturer provides software (also referred to herein as an encoding library) which reads from the unprotected memory and uses a hash to generate a password which is the key to the locked portion of memory of the device to allow access to locked memory. Another hash is performed on the readable data to generate another field (the hidden hash string) that is stored in the locked memory area. Once both the unlocking and the check that the generated hash string matches the data in the locked memory, the device is useable.

The software provided to the vendor is used to acquire a number of bytes from the readable area and generate two strings. One string (a hashed password) is used to program the key to the locked memory and then used to unlock the memory. The other string (a hidden hash string) is then written into the locked area. This is done during the manufacturing process. Due to the fields used to generate the strings (e.g. a serial number or some other number that is unique for each part) the strings will be unique for each part.

When a system receives the device, it will read and validate the memory fields by generating the exact same strings (referred to herein as a second hashed password which should match the first hashed password and a second hidden hash string which should match the first hidden hash string). The system will use the first string to unlock the device memory and verify the stored hidden hash string matches the second string.

This prevents others from just copying the readable memory and printing the information into every part. In the past the necessary security against nefarious parts manufacturers could be easily overcome. By way of the presently described invention, an additional set of security checks is provided. By way of reading different fields for each of the two passwords, and using two different hash keys, it becomes much more difficult to unlock memory and use the device.

If someone is somehow able to copy the part exactly, the code detects that there is a more than one part with the same information and does not allow any additional devices to be enabled beyond the first one.

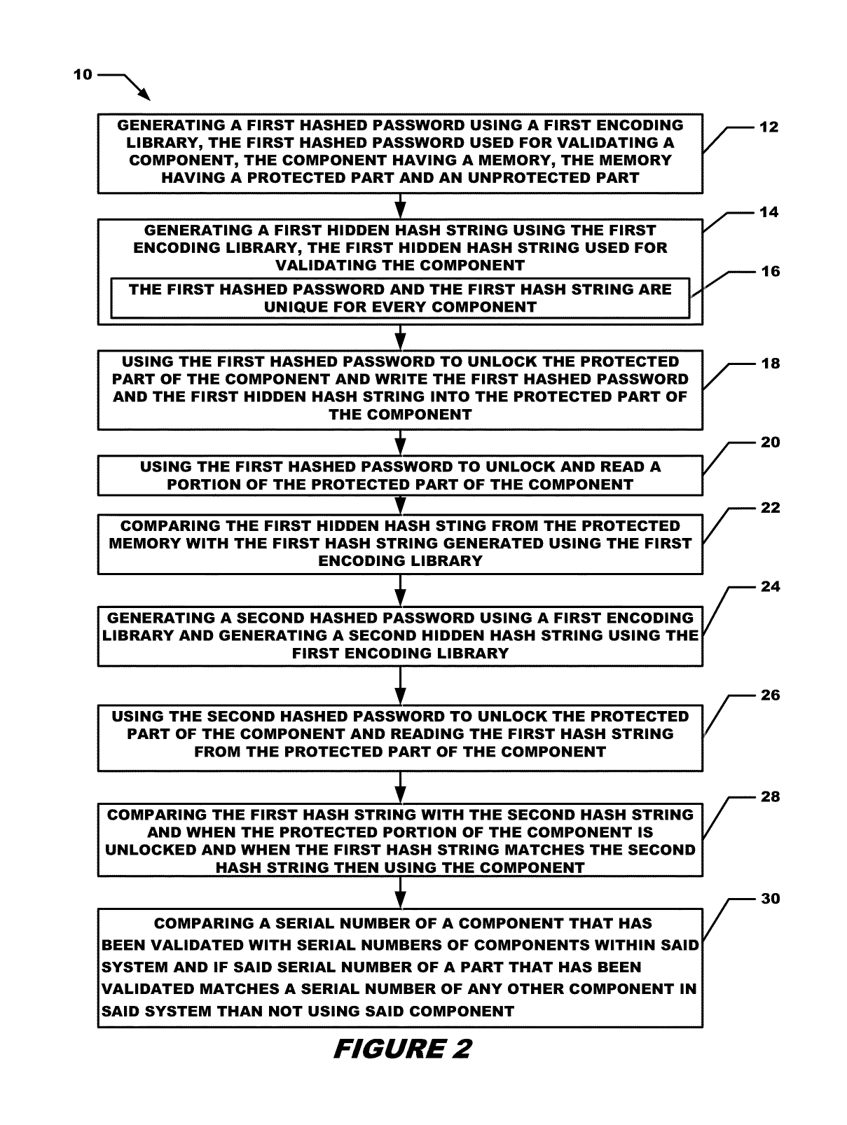

A flow chart of a particular embodiment of the presently disclosed method 10 is depicted in FIG. 2. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 2, the method 10 begins with processing block 12 which discloses generating a first hashed password using a first encoding library, the first hashed password used for validating a component, the component having a memory, the memory having a protected part and an unprotected part. Processing block 14 states generating a first hidden hash string using the first encoding library, the first hidden hash string used for validating the component. Processing block 16 recites the first hashed password and the first hash string are unique for every component. The encoding library uses existing fields in the components memory, at least one of which is unique for each device, such as a serial number or the like.

Processing block 18 discloses using the first hashed password to unlock the protected part of the component and write the first hashed string into the protected part of the component. Processing block 20 states using the first hashed password to unlock the protected part of the component and write the first hidden hash string into the protected part of the component. The component now has two unique pieces of data in the locked part of memory, which will be used later to verify the component.

Processing continues with processing block 20 which describes the steps for validating the component. As shown in processing block 20 the validating includes generating the first hashed password to unlock and read a portion of the protected part of the component. As further shown in processing block 22 the validating also includes comparing the first hidden hash sting from the protected memory with the first hash string generated using the first encoding library.

Processing continues at the point where the component is integrated into a system at a system provider. Processing block 24 states generating a second hashed password using a first encoding library and generating a second hidden hash string using the first encoding library.

Processing block 26 recites using the second hashed password to unlock the protected part of the component and reading the first hash string from the protected part of the component.

Processing block 28 discloses comprising comparing the first hash string with the second hash string when the protected portion of the component is unlocked and when the first hash string matches the second hash string then using the component.

Processing block 30 states comparing a serial number of a component that has been validated with serial numbers of components within said system and if said serial number of a part that has been validated matches a serial number of any other component in said system than not using said component.

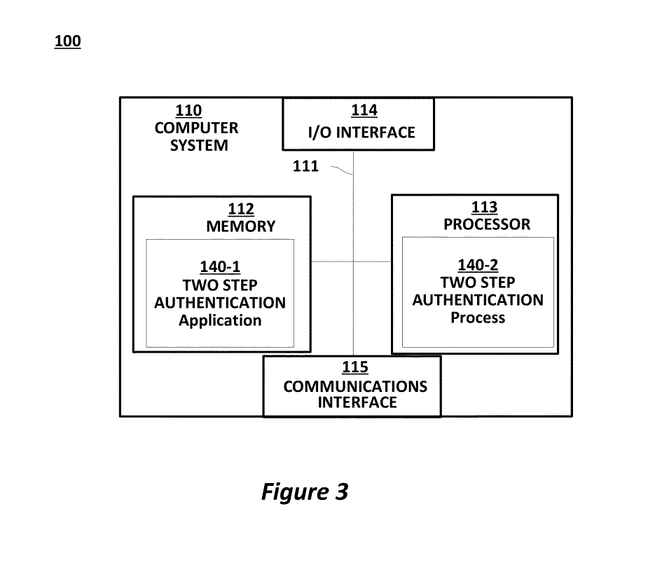

FIG. 3 is a block diagram illustrating example architecture of a computer system 110 that executes, runs, interprets, operates or otherwise performs a two step authentication operating application 140-1 and two step authentication operating process 140-2 suitable for use in explaining example configurations disclosed herein. The computer system 110 may be any type of computerized device such as a personal computer, workstation, portable computing device, console, laptop, network terminal or the like. An input device 116 (e.g., one or more customer/developer controlled devices such as a keyboard, mouse, etc.) couples to processor 113 through I/O interface 114, and enables a customer 108 to provide input commands, and generally control the graphical customer interface 160 that the two step authentication operating application 140-1 and process 140-2 provides on the display 130. Essentially, the graphical user interface 160 is where the customer 108-1 performs their ‘online banking’, specifying which bills are to be paid electronically, when those bills are to be paid, and the amount to be paid. As shown in this example, the computer system 110 includes an interconnection mechanism 111 such as a data bus or other circuitry that couples a memory system 112, a processor 113, an input/output interface 114, and a communications interface 115. The communications interface 115 enables the computer system 110 to communicate with other devices (i.e., other computers) on a network (not shown).

The memory system 112 is any type of computer readable medium, and in this example, is encoded with a two step authentication operating application 140-1 as explained herein. The two step authentication operating application 140-1 may be embodied as software code such as data and/or logic instructions (e.g., code stored in the memory or on another computer readable medium such as a removable disk) that supports processing functionality according to different embodiments described herein. During operation of the computer system 110, the processor 113 accesses the memory system 112 via the interconnect 111 in order to launch, run, execute, interpret or otherwise perform the logic instructions of a two step authentication operating application 140-1. Execution of a two step authentication operating application 140-1 in this manner produces processing functionality in the two step authentication operating process 140-2. In other words, the two step authentication operating process 140-2 represents one or more portions or runtime instances of a two step authentication operating application 140-1 (or the entire a two step authentication operating application 140-1) performing or executing within or upon the processor 113 in the computerized device 110 at runtime.

It is noted that example configurations disclosed herein include the two step authentication operating application 140-1 itself (i.e., in the form of un-executed or non-performing logic instructions and/or data). The two step authentication operating application 140-1 may be stored on a computer readable medium (such as a floppy disk), hard disk, electronic, magnetic, optical, or other computer readable medium. A two step authentication operating application 140-1 may also be stored in a memory system 112 such as in firmware, read only memory (ROM), or, as in this example, as executable code in, for example, Random Access Memory (RAM). In addition to these embodiments, it should also be noted that other embodiments herein include the execution of a two step authentication operating application 140-1 in the processor 113 as the two step authentication operating process 140-2. Those skilled in the art will understand that the computer system 110 may include other processes and/or software and hardware components, such as an operating system not shown in this example.

A display 130 need not be coupled directly to computer system 110. For example, the two step authentication operating application 140-1 can be executed on a remotely accessible computerized device via the network interface 115. In this instance, the graphical customer interface 160 may be displayed locally to a customer 108 of the remote computer, and execution of the processing herein may be client-server based.

During operation, processor 113 of computer system 100 accesses memory system 112 via the interconnect 111 in order to launch, run, execute, interpret or otherwise perform the logic instructions of the two step authentication operating application 140-1. Execution of two step authentication operating application 140-1 produces processing functionality in two step authentication operating process 140-2. In other words, the two step authentication operating process 140-2 represents one or more portions of the two step authentication operating application 140-1 (or the entire application) performing within or upon the processor 113 in the computer system 100.

It should be noted that, in addition to the two step authentication operating process 140-2, embodiments herein include the two step authentication operating application 140-1 itself (i.e., the un-executed or non-performing logic instructions and/or data). The two step authentication operating application 140-1 can be stored on a computer readable medium such as a floppy disk, hard disk, or optical medium. The two step authentication operating application 140-1 can also be stored in a memory type system such as in firmware, read only memory (ROM), or, as in this example, as executable code within the memory system 112 (e.g., within Random Access Memory or RAM).

In addition to these embodiments, it should also be noted that other embodiments herein include the execution of two step authentication operating application 140-1 in processor 113 as the two step authentication operating process 140-2. Those skilled in the art will understand that the computer system 100 can include other processes and/or software and hardware components, such as an operating system that controls allocation and use of hardware resources associated with the computer system 100.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A computer-implemented method comprising:
generating a first hashed password using a first encoding library, said first hashed password used for validating a component, said component having a memory, said memory having a protected part and an unprotected part;
generating a first hidden hash string using said first encoding library, said first hidden hash string used for validating said component;
using said first hashed password to unlock said protected part of said component and write said first hashed password into said protected part of said component; and
using said first hashed password to unlock said protected part of said component and write said first hidden hash string into said protected part of said component.

2. The method of claim 1 further comprising validating said component, said validating comprising:
using said first hashed password to unlock and read a portion of said protected part of said component; and
comparing said first hidden hash sting from said protected memory with said first hash string generated using said first encoding library.

3. The method of claim 1 wherein said first hashed password and said first hash string are unique for every component.

4. The method of claim 1 wherein said component comprises a Quad Small Form Factor Pluggable QFSP+ transceiver.

5. The method of claim 1 further comprising, at a system provider:
generating a second hashed password using a first encoding library; and
generating a second hidden hash string using said first encoding library.

6. The method of claim 5 further comprising using said second hashed password to unlock said protected part of said component and reading said first hash string from said protected part of said component.

7. The method of claim 6 further comprising comparing said first hash string with said second hash string and when said protected portion of said component is unlocked and when said first hash string matches said second hash string then using said component.

8. The method of claim 7 further comprising comparing a serial number of a component that has been validated with serial numbers of components within said system and if said serial number of a part that has been validated matches a serial number of any other component in said system than not using said component.

9. A non-transitory computer readable storage medium having computer readable code thereon for two-step authentication and activation of Quad Small Form Factor Pluggable (QFSP+) transceivers, the medium including instructions in which a computer system performs operations comprising:
generating a first hashed password using a first encoding library, said first hashed password used for validating a component, said component having a memory, said memory having a protected part and an unprotected part;
generating a first hidden hash string using said first encoding library, said first hidden hash string used for validating said component;
using said first hashed password to unlock said protected part of said component and write said first hashed password into said protected part of said component; and
using said first hashed password to unlock said protected part of said component and write said first hidden hash string into said protected part of said component.

10. The computer readable storage medium of claim 9 further comprising validating said component, said validating comprising:
using said first hashed password to unlock and read a portion of said protected part of said component; and
comparing said first hidden hash sting from said protected memory with said first hash string generated using said first encoding library.

11. The computer readable storage medium of claim 9 wherein said first hashed password and said first hash string are unique for every component.

12. The computer readable storage medium of claim 9 further comprising, at a system provider:
generating a second hashed password using a first encoding library; and
generating a second hidden hash string using said first encoding library.

13. The computer readable storage medium of claim 14 further comprising using said second hashed password to unlock said protected part of said component and reading said first hash string from said protected part of said component.

14. The computer readable storage medium of claim 13 further comprising comparing said first hash string with said second hash string and when said protected portion of said component is unlocked and when said first hash string matches said second hash string then using said component.

15. The computer readable storage medium of claim 14 further comprising comparing at least one of said first hashed password and said first hash string and if at least one of said first hashed password and said first hash string match a password or hash string of any other component in said system than not using said component.

16. A computer system including two computers, each said computer comprising:
a memory;
a processor;
a communications interface;
an interconnection mechanism coupling the memory, the processor and the communications interface; and
wherein the memory is encoded with an application providing two-step authentication and activation of Quad Small Form Factor Pluggable (QFSP+) transceivers, that when performed on the processors, provides a process for processing information, the process causing the computer system to perform the operations of:
generating a first hashed password using a first encoding library, said first hashed password used for validating a component, said component having a memory, said memory having a protected part and an unprotected part;
generating a first hidden hash string using said first encoding library, said first hidden hash string used for validating said component;
using said first hashed password to unlock said protected part of said component and write said first hashed password into said protected part of said component; and
using said first hashed password to unlock said protected part of said component and write said first hidden hash string into said protected part of said component.

17. The computer system of claim 16 further comprising validating said component, said validating comprising:
using said first hashed password to unlock and read a portion of said protected part of said component; and
comparing said first hidden hash sting from said protected memory with said first hash string generated using said first encoding library.

18. The computer system of claim 16 further comprising, at a system provider:
generating a second hashed password using a first encoding library; and
generating a second hidden hash string using said first encoding library.

19. The computer system of claim 18 further comprising using said second hashed password to unlock said protected part of said component and reading said first hash string from said protected part of said component.

20. The computer system of claim 19 further comprising:
comparing said first hash string with said second hash string and when said protected portion of said component is unlocked and when said first hash string matches said second hash string then using said component; and
comparing a serial number of a component that has been validated with serial numbers of components within said system and if said serial number of a part that has been validated matches a serial number of any other component in said system than not using said component.
